(19) United States
(12) Patent Application Publication
(10) Pub. No.: US 2016/0030924 A9
(43) Pub. Date: Feb. 4, 2016

(54) POROUS COMPOSITE PARTICULATE MATERIALS, METHODS OF MAKING AND USING SAME, AND RELATED APPARATUSES

(71) Applicants: BRIGHAM YOUNG UNIVERSITY, Provo, UT (US); US SYNTHETIC CORPORATION, Orem, UT (US)

(72) Inventors: David Scott Jensen, Provo, UT (US); Andrew E. Dadson, Provo, UT (US); Matthew R. Linford, Orem, UT (US)

(21) Appl. No.: 14/463,525

(22) Filed: Aug. 19, 2014

Related U.S. Application Data
(63) Continuation-in-part of application No. 12/774,777, filed on May 6, 2010, now Pat. No. 9,192,915.
Application No. 12/774,777 is a continuation-in-part of application No. 12/463,899, filed on May 11, 2009, now Pat. No. 9,005,436.
(60) Provisional application No. 61/868,186, filed on Aug. 21, 2013.
(60) Provisional application No. 61/052,185, filed on May 10, 2008.

(51) Int. Cl. B01J 20/32; B01J 20/281; B01D 15/26

(52) U.S. Cl. CPC B01J 20/3293; B01D 15/26; B01J 20/281; B01J 2220/82; B01J 2220/58

(57) ABSTRACT

In an embodiment, a porous composite particulate material includes a plurality of composite particles. Each composite particle includes an acid-base-resistant core particle at least partially surrounded by one or more layers of acid-base-resistant shell particles. The shell particles are adhered to the core particle by a polymeric layer. The shell particles and/or core particles may be made from an acid-base-resistant material that is stable in harsh chemical conditions. For example, the shell particles may be made from diamond, graphitic carbon, silicon carbide, boron nitride, tungsten carbide, niobium carbide, zirconia, noble metals, combinations of the foregoing, or other acid-base-resistant materials and the core particle may include at least one exterior layer of non-diamond carbon. The porous composite particulate materials disclosed herein and related methods and devices may be used in separation technologies, including, but not limited to, chromatography and solid phase extraction.

This application is a continuation-in-part of U.S. application Ser. No. 12/774,777 filed on 6 May 2010 and also claims priority to U.S. Provisional Application No. 61/868,186 filed on 21 Aug. 2013, the disclosure of each the foregoing applications is incorporated herein, in its entirety, by this reference.

### BACKGROUND

Chromatography and solid-phase extraction (“SPE”) are commonly-used separation techniques employed in a variety of analytical chemistry and biochemistry environments. Chromatography and SPE are often used for separation, extraction, and analysis of various constituents, or fractions, of a sample of interest. Chromatography and SPE may also be used for the preparation, purification, concentration, and clean-up of samples.

Chromatography and SPE relate to any of a variety of techniques used to separate complex mixtures based on differential affinities of components of a sample carried by a mobile phase with which the sample flows, and a stationary phase through which the sample passes. Typically, chromatography and SPE involve the use of a stationary phase that includes an adsorbent packed into a cartridge or column. A commonly-used stationary phase includes a silica-gel-based sorbent material.

Mobile phases are often solvent-based liquids, although gas chromatography typically employs a gaseous mobile phases. Liquid mobile phases may vary significantly in their compositions depending on various characteristics of the sample being analyzed and on the various components sought to be extracted and/or analyzed in the sample. For example, liquid mobile phases may vary significantly in pH and solvent properties. Additionally, liquid mobile phases may vary in their compositions depending on the characteristics of the stationary phase that is being employed. Often, several different mobile phases are employed during a given chromatography or SPE procedure. Stationary phase materials may also exhibit poor stability characteristics in the presence of various mobile phase compositions and/or complex mixtures for which separation is desired. The poor stability characteristics of stationary phase materials in some mobile phases and complex mixtures, in some cases, may even preclude the possibility of using chromatography or SPE to perform the desired separation.

### SUMMARY

Embodiments disclosed herein are directed to porous composite particulate materials, related methods of manufacture, and devices that incorporate such porous composite particulate materials for use in separation technologies, including, but not limited to, chromatography and solid phase extraction. In an embodiment, a porous composite particulate material includes a plurality of composite particles. Each composite particle includes an acid-base-resistant core particle at least partially surrounded by one or more layers of acid-base-resistant shell particles. At least a number of the acid-base-resistant core particles include at least one exterior layer of non-diamond carbon. The shell particles may be bonded to the core particles by a polymeric layer of one or more polymers, which is acid-base resistant. For example, the polymeric layer may be highly cross-linked to provide mechanical stability, while still providing sufficient chemical stability. The shell particles and/or core particles may also be made from a material that is stable in harsh chemical conditions. For example, the shell particles may be made from diamond, graphitic non-diamond carbon, nanographite, silicon carbide, boron nitride, tungsten carbide, niobium carbide, zirconia, noble metals, acid-base-stable highly cross-linked polymers, titania, alumina, combinations thereof, or other suitable acid-base-resistant material that is chemically stable in acids and bases over a wide pH range. The core particles may be made from a particle including at least one exterior layer of non-diamond carbon, such as an at least partially carbonized polymeric particle. In an embodiment, the shell particles comprise diamond, a diamond-like material, a graphitic material, or combinations of the foregoing, and the core particles may be selected to be generally spherical and comprise an at least partially carbonized polymeric particle.

The one or more polymers used to adhere the shell particles to the core particles and/or to each other may also be selected to be stable in harsh chemical conditions. For example, in an embodiment, the one or more adhering polymer may be an amine polymer. The one or more adhering polymers may also be cross-linked (e.g., using epoxide moieties) to add mechanical strength to polymeric binding matrix and/or include functionalizing moieties (e.g., anionic moieties) to give the composite particulate material desired properties for separating components of a mobile phase. In another embodiment, the adhering polymers may also be substantially neutral polymers (i.e., non-ionic). Substantially neutral polymers may have a few ionic groups so long as the molecule is large enough that the molecule behaves similar to typical non-ionic polymers (e.g., a PMMA molecule having a few amines). An example of a substantially neutral polymer is poly(allylamine) (“PAAm”) because the neutral amines on PAAm remain largely unprotonated in an aqueous solution.

The shell particles may be bonded to the outside of the core particle to achieve a composite particle with a desired size and/or surface area. Moreover, the relative size of the core particles and shell particles and the number of layers of shell particles may be selected to provide composite particles with a surface area and porosity suitable for chromatography and/or solid phase extraction. The use of core particles bonded to shell particles provides combinations of particle sizes and surface areas that may not be possible with simple mixtures of un-bonded particles of the same material.

In an embodiment, a method for manufacturing a porous composite particulate material includes providing a plurality of acid-base-resistant core particles at least a number of which include at least one exterior layer of non-diamond carbon and a plurality of acid-base-resistant shell particles. At least a portion of the core particles, at least a portion of the shell particles, or both may be coated with polymeric material. A portion of the shell particles are adhered to each core particle to form a plurality of composite particles. For example, each core particle may have a plurality of shell particles bonded thereto by the polymer material.

In another embodiment, a separation apparatus for performing chromatography or solid phase separation is described. The separation apparatus includes a vessel having an inlet and an outlet. Any of the porous composite particulate materials disclosed herein may be disposed within the vessel. The vessel may be a column or a cassette suitable for use in the fields of chromatography and/or solid phase separation (e.g., high performance liquid chromatography (“HPLC”) and ultra performance liquid chromatography (“UPLC”)).

The separation apparatus may be used to physically separate different components from one another. In an embodiment, a mobile phase including at least two different components to be separated is caused to flow through the composite particulate material to physically separate the at least two different components. At least one of the two different components is recovered.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical elements or features in different views or embodiments shown in the drawings.

FIG. 1 is a schematic flow diagram illustrating a method for making a composite particulate material according to an embodiment;

FIG. 2 is a schematic diagram illustrating another method for making a composite particulate material according to an embodiment;

FIG. 3 is a cross-sectional view of a vessel used for forming a body of bonded composite particles according to an embodiment;

FIG. 4 is a cross-sectional view of a composite particle according to an embodiment;

FIG. 5 is a cross-sectional view an embodiment of a separation apparatus including a porous body comprising any of the porous composite particulate materials disclosed herein;

FIG. 6 are chromatograms of an alkybenzene test mixture that tested the stability of Example 6 in a column at various temperatures.

### DETAILED DESCRIPTION

### I. Components Used to Make Porous Composite Particulate Materials

A. Acid-Base-Resistant Particles

The porous composite particulate materials disclosed herein include a plurality of composite particles. Each composite particle includes an acid-base-resistant core particle, and a plurality of acid-base-resistant shell particles that at least partially surround and are bonded to the core particle by a polymeric layer of polymer material to impart a desired size and surface area. The core particles and shell particles may be made from the same material or different materials. The core particles and/or shell particles may be of a solid, porous, composite, synthetic, and/or natural occurring material. For example, the shell particles may be made from diamond, graphitic non-diamond carbon, nanographite, silicon carbide, boron nitride, tungsten carbide, niobium carbide, zirconia, noble metals, acid-base-stable highly cross-linked polymers, titania, alumina, combinations thereof, or other suitable acid-base-resistant material that is chemically stable in acids and bases over a wide pH range. For example, the nanographite may have a particle size of about 1 μm or less. At least a number of the core particles include at least one exterior layer of non-diamond carbon. As described in more detail below, the core particles may be made from a particle including at least one exterior layer of non-diamond carbon, such as an at least partially carbonized polymeric particle. As used herein, the term “highly cross-linked polymers” refers to polymers with sufficient cross-linking that prevent swelling of the polymer in the presence of an organic solvent (e.g., prevent greater than 1% swelling or greater than 5% swelling). In one or more embodiments, the cross-linking may be about 1% to about 99%, at least about 70%, about 55% to about 75%, about 75% to about 95%, at least about 85%, at least about 95%, or even at least about 99%. However, in some embodiments using percentages less than about 99%, less than about 95%, or less than 85% may be useful so that the polymer exhibits a sufficient toughness to avoid cracking during use.

The core particles and the shell particles may have the same or different particle sizes. As used herein, the phrase “particle size” means the approximate average particle size, such as average diameter or other average cross-sectional dimension of a plurality of particles, unless otherwise specified. In an embodiment, the shell particles are much smaller than the core particles to achieve a desired composite-particle surface area. In an embodiment, the shell particles have a particle size that is in a range from about 1 nm to 1000 nm, more specifically in a range from about 2 nm to about 500 nm, even more specifically in a range from about 5 nm to about 200 nm, and yet even more specifically in a range from about 10 nm to about 100 nm (e.g., about 10 nm to about 20 nm). The core particles may have a particle size in a range from about 0.5 μm to about 500 μm, more specifically about 1 μm to about 200 μm, or even more specifically in a range from about 1 μm to about 100 μm. The desired particle size of the core particles may depend on the application in which the composite particle is to be used. In an embodiment, the core particles have a particle size in a range from about 0.5 μm to 10 μm, more specifically about 1.5 μm to about 7 μm. This range may be suitable for HPLC applications and the like. In another embodiment, the particle size of the core particles may be in a range from about 5 μm to about 500 μm, or more specifically in a range from about 10 μm to about 150 μm. This larger range may be suitable for solid phase extraction applications and the like.

The acid-base-resistant shell and core particles may have a composition that is selected to be stable in sundry mobile phases, including organic solvents, and chemically harsh acids and bases. Examples of acid-base-resistant materials from which the shell particles and the core particles may be made include, but are not limited to, diamond, graphitic carbon (e.g., graphite) or other types of non-diamond carbon, silicon carbide, or another suitable material that is chemically stable in acids and bases over a pH range of at least 3 to 12. For example, diamond, graphite, and silicon carbide are chemically stable in acids and bases over a pH range of about 0 to about 14. Silica and alumina are examples of materials that are not acid-base-resistant materials, because they may significantly degrade in bases with a pH greater than 12. Other relatively acid-base-resistant materials include, but are not limited to, boron nitride and tungsten carbide. Yet other examples of other acid-base-resistant materials include zirconia, noble metals, acid-base stable highly cross-linked polymers, titania, alumina, thoria, or combinations of the foregoing. Further embodiments of acid-base-resistant material may be a polymer that is at least partially cross-linked.

Diamond possesses remarkable chemical inertness, hardness, low compressibility, optical transparency, and high thermal conductivity that may help eliminate thermal gradients in ultra performance liquid chromatography. Unlike silica, diamond does not easily dissolve in aqueous alkaline or acidic media, and it may be used in extremely harsh chemical environments. These properties of diamond may be achieved with naturally occurring diamond and/or synthetic diamond. Diamond material may also include other inorganic carbon materials, such as graphitic carbon, fullerenes, combinations thereof, or other non-diamond carbon.

The acid-base-resistant shell and core particles may be produced through any suitable method, including, for example, by forming carbonaceous material into diamond material under ultra-high pressure and high-temperature conditions or other synthetic diamond particles. Additionally, the acid-base-resistant shell and core particles may be the product of natural processes or by chemical vapor deposition processes. Acid-base-resistant shell and core particles may be produced by crushing and/or grinding a mineral starting material to obtain a desired sized particle. In an embodiment, the acid-base-resistant core particles may comprise micron-sized non-diamond carbon particles with, for example, a particle size of about 1 μm to about 500 μm (e.g., about 1 μm to about 100 μm) and the acid-base-resistant shell particles may comprise diamond particles, with for example, a particle size of about 1 nm to 1000 nm (e.g., about 2 nm to about 200 nm). The acid-base-resistant shell and core particles may have a spherical shape, a faceted shape, an irregular shape, or other suitable geometry.

In some embodiments, the acid-base-resistant core particles may be substantially non-porous. However, in other embodiments, the acid-base-resistant core particles may be porous.

In an embodiment, the acid-base-resistant shell and/or core particles are selected to be generally spherical. While most, if not all, the particle materials disclosed herein may be made into generally spherical particles, certain materials are more easily produced as generally spherical particles. For example, in an embodiment the acid-base-resistant shell and core particles may be generally spherical, and may comprise graphite or other non-diamond carbon, zirconia, titania, noble metals, acid-base-resistant highly cross-linked polymers, acid-base-resistant at least partially cross-linked polymers, alumina, thoria, or combinations of these.

While generally spherical particles may be used as shell particles, generally spherical particles may be more advantageously used as core particles. The use of non-spherical core particles typically has a more negative impact on the back pressure and mobile phase flow profile created by the composite particles compared to spherical shell particles and the reproducibility of the porous composite particulate materials. Moreover, because the core particles may be substantially isolated from the mobile phase by the shell particles and polymeric materials, the materials used to make the core particles may be less compatible with the constituents of the mobile phase as compared to the shell particles. Thus, the core particles may more readily be configured to have a generally spherical geometry. In an embodiment, a generally spherical core particle includes a material selected from the group of zirconia, titania, noble metals, acid-base-resistant highly cross-linked polymers, acid-base-resistant at least partially cross-linked polymers, alumina, thoria, or any combination thereof.

In an embodiment, the core particle may be a composite particle including an inner region and at least one cladding layer partially or completely encapsulating/surrounding the inner region. The inner region may include materials that are acid-base unstable and/or incompatible with constituents of a mobile phase. The inner region of the core particle may include a ceramic, polymeric, or metallic material that may be unstable in acids and bases (e.g. silica gel) and/or non-compatible with certain constituents of chromatography mobile phases. In this embodiment, the cladding layer may be made from an acid-base resistant material that gives the core particles acid-base resistant properties and/or compatibility, such as non-diamond carbon. In an embodiment, the cladding material may be made from any of the acid-base resistant materials disclosed herein, including, but not limited to, diamond, graphitic carbon or other non-diamond carbon, tungsten carbide, niobium carbide, boron nitride, zirconia, noble metals, acid-base-stable highly cross-linked polymers, titania, alumina, thoria, and any combinations thereof. In contrast, the materials used in the inner region may be made from any material upon which the cladding layer may be deposited. While not required, the materials used in the inner region may even be acid-base unstable so long as the cladding layer substantially encapsulates the acid-base unstable material.

The core particles including the inner region and the at least one cladding layer may be manufactured by starting with an inner particle made from a ceramic, a polymer, or a metal upon which the cladding layer is deposited. The inner particle may have an average diameter ranging from about 0.5 μm to about 50 μm, more specifically about 0.75 μm to about 10 μm, or even more specifically about 1 μm to about 5 μm. The cladding layer may be applied as a thin coating. In an embodiment, the cladding layer has a thickness less than 5 μm, more specifically less than 1 μm, even more specifically less than 0.5 μm. The cladding layer may be applied to the inner particle using any technique known in the art, including but not limited to chemical vapor deposition, physical vapor deposition, atomic layer deposition, or another suitable deposition technique.

In another embodiment, the cladding layer may be formed on the inner particle by dipping the inner particles in a carbonizable polymer and then heating the material to form graphitic carbon. A variety of reagents (e.g., resins, polymers, and catalysts) may be used to make graphitic carbon through pyrolysis and similar methods. In an embodiment, a core particle including the cladding may be made by (i) providing a generally spherical inner particle made from a ceramic, polymer, or metal, (ii) dipping the inner particle in a melt of polymerizable resin such phenol and hexamine (6:1 w/w); (iii) remove excess melt, (iv) heating the coated particles gradually (e.g., to 150° C.) to form the phenol formaldehyde resin around the particles; and (v) carbonizing the resin around the particles by slow heating (e.g., less than 5° C./min) in an oxygen free oven to form a substantially impervious carbonaceous/glassy carbon shell. For example, the resin may be carbonized by heating, such as heating to about 900° C. to form at least one exterior layer of non-diamond carbon to substantially surround and encapsulate the inner particle so the inner particle is no longer exposed.

In yet another embodiment, the inner particles may be coated with the polymer by applying a polymeric material, while forcing air or other gas up through the particles to suspend the particles. Producing a core particle using an inner particle and a cladding layer is useful for forming generally spherical particles. In an embodiment, the inner region may be manufactured to be spherical and the cladding layer may be applied to the generally spherical inner region to yield a generally spherical core particle.

In yet a further embodiment, the core particle may be composed of a non-diamond carbon material that is derived from a polymeric material, such as substantially homogenous polymeric material. For example, poly(divinylbenzene) (“PDVB”) microspheres or other suitable polymer microspheres may be used as precursor core particles that are subsequently at least partially carbonized to form a non-diamond carbon material. For example, a core particle may be formed that consists essentially of or is substantially only non-diamond sp² carbon such as graphitic carbon. In other embodiments, the non-diamond carbon material may comprise more than 60 volume %, more than 70 volume %, more than 80 volume %, more than 90 volume %, about 70 volume % to about 90 volume %, about 80 volume % to about 90 volume %, or about 85 volume % to about 95 volume % of the core particle. In an embodiment, the microspheres comprising PDVB or microspheres comprising another type of polymeric material may be air-oxidized and carbonized (or otherwise converted) to the non-diamond carbon material core particle. In an embodiment, the oxidation/carbonization heat treatment may be performed in air at a temperature of about 600° C. to about 900° C., such as about 700° C. to about 900° C. As the heat treatment temperature increases, the resultant particle size of the non-diamond carbon material core particle may be relatively smaller. For example, the resultant non-diamond carbon material core particles may exhibit an average diameter of about 2.5 μm to about 3.5 μm, such as about 2.8 μm to about 3.3 μm. Further details about the oxidation/carbonization heat treatment that may be used to convert the PDVB microspheres is disclosed in the article by Li, L., Song, H., Chen, X., Materials Letters 2008, 62, 179-182, the disclosure of which is incorporated herein, in its entirety, by this reference. In some embodiments, after carbonization, the carbonized core particles may again be oxidized. For example, the second oxidation treatment may be performed by exposing the carbonized core particles to a suitable acid or mixture of acids, such as nitric acid, piranha solution (70% H₂SO₄:30% concentrated H₂O₂), or mixtures thereof.

In yet a further embodiment, the shell particles may be composed of a non-diamond carbon material that is derived from a polymeric material, such as substantially homogenous polymeric material. For example, PDVB microspheres, PDVB nanospheres, or other suitable polymer spheres may be used as precursor shell particles that are subsequently at least partially carbonized to form a non-diamond carbon material. For example, a shell particles may be formed that consists essentially of or is substantially only non-diamond sp² carbon such as graphitic carbon. In other embodiments, the non-diamond carbon material may comprise more than 60 volume %, more than 70 volume %, more than 80 volume %, more than 90 volume %, about 70 volume % to about 90 volume %, about 80 volume % to about 90 volume %, or about 85 volume % to about 95 volume % of the shell particles. In an embodiment, the microspheres comprising PDVB or microspheres comprising another type of polymeric material may be air-oxidized and carbonized (or otherwise converted) to the non-diamond carbon material core particle. In an embodiment, the oxidation/carbonization heat treatment may be performed in air at a temperature of about 600° C. to about 900° C., such as about 700° C. to about 900° C. as described above for the core particles. As the heat treatment temperature increases, the resultant particle size of the non-diamond carbon material shell particles may be relatively smaller. For example, the resultant non-diamond carbon material shell particles may exhibit an average diameter of about 1 nm to 1000 nm (e.g., about 2 nm to about 200 nm). In some embodiments, after carbonization, the carbonized shell particles may again be oxidized. For example, the second oxidation treatment may be performed by exposing the carbonized shell particles to a suitable acid or mixture of acids, such as nitric acid, piranha solution, or mixtures thereof.

B. Polymeric Materials

The coating or binding polymer used to bond to the shell particles to the core particle and/or other shell particles may be any polymeric material that may be applied in a coating to adhere the acid-base-resistant particles to one another. For example, the polymer coating may include a polymeric material comprising one or more polymers that provide the porous composite particulate material desired properties for separating components of a mobile phase. The polymer coating may also be stable over the same pH ranges as the acid-base-resistant core and shell particles to provide a chemically resistant polymer coating. The polymer coating may include macromonomers, oligomers, and/or various polymers, without limitation. The polymer coating may include combinations and/or mixtures of different polymeric materials and/or used to form different layers of polymers as described more fully below.

In an embodiment, the polymer coating or binding polymer may include at least one amine group. The amine polymer may be selected to be chemically stable in many of the same mobile phases that diamond particles or other acid-base-resistant materials disclosed herein are stable. In an embodiment, the amine polymer includes at least one pendant amine group and/or at least one primary, secondary, tertiary, and/or quaternary amine group. In various embodiments, the polymer coating may include for example, PAAm, polyethylenimine, polylysine, polyvinylamine, chitosan, trimethylchitosan (i.e., quaternized chitosan), polydiallydimethyl ammonium chloride (“PDADMAC”), poly(N,N′-dimethylaminoethylmethacrylate), poly(2-vinylpyridine), poly(4-vinylpyridine), polyvinylimidazole, poly(2-(dimethylamino)ethyl acrylate), and/or poly(2-aminoethyl methacrylate) hydrochloride, combinations of the foregoing, and/or derivatives of the foregoing.

Polyethylenimine may be present in the polymer coating in a wide range of molecular weights and degrees of branching. Chitosan may be produced by the deacetylation of chitin, and chitin may be deacetylated to various degrees. Polymers in the coating may be substantially linear or at least partially branched. Polymers including amines therein may be protonated, deprotonated, or partially protonated prior to, during, and/or following deposition on a surface. Additionally, the polymer coating may comprise any suitable naturally occurring proteins and/or peptides.

In additional embodiments, the polymer coating may include a homopolymer and/or a copolymer compound formed from monomer subunits including, for example, allylamine, vinylamine, ethylenimine, vinyl amine, lysine, arginine, histidine, 2-isocyanatoethyl methacrylate, aziridine, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, and/or 2-(tert-butyl amino)ethyl methacrylate.

Additionally, the polymer coating may include any suitable monomers that may be converted into amines after polymerization by deprotection, hydrolysis, and/or by simple chemical transformation. In various embodiments, the polymer coating may include monomers based on oxazoline, which may be polymerized to form polyoxazolines and/or which may then be hydrolyzed. Amine-comprising monomers forming a polymeric compound in coating may be protonated, deprotonated, or partially protonated prior to, during, and/or following polymerization. The amine polymers may also be substantially neutral polymers.

In at least an embodiment, monomers forming a polymer in the polymer coating may be interspersed with other monomer units such as 2-hydroxyethylacrylate, styrene, 1,3-butadiene, methyl methacrylate, methyl acrylate, butyl acrylate, dodecyl methacrylate, acrylonitrile, acrylic acid, methacrylic acid, 4-vinylbenzyl chloride, 4-(trifluoromethyl)styrene, 3-nitrostyrene, vinyl ether, or vinyl acetate.

The polymer coating may include a polymeric compound having various chain lengths and various degrees of branching. For example, the polymeric coating may include a polymeric compound having a weight-average molecular weight or number-average molecular weight ranging from about 1,000 to about 2,500,000. In certain embodiments, the polymer coating may include a polymeric compound having a weight-average molecular weight or number-average molecular weight ranging from about 5,000 to about 100,000. Additionally, the polymer coating may include a polymeric compound having a weight-average molecular weight or number-average molecular weight ranging from about 30,000 to about 60,000 monomer units. In additional embodiments, the polymer coating may include polymeric compounds having a weight-average molecular weight or number-average molecular weight of less than about 1,000. The polymer coating may optionally include oligomers having a chain length of from 2 to 100 monomer units in length. As used herein, the term “polymeric compound” includes oligomers as well as polymers of varying chain lengths and molecular weights, unless otherwise specified.

Additional information about suitable polymers for use in the porous composite particulate materials disclosed herein may also be found in U.S. patent application Ser. No. 12/039,382 filed on 28 Feb. 2008, entitled “Methods For Direct Attachment Of Polymers To Diamond Surfaces And Articles Formed Thereby,” which is hereby incorporated herein, in its entirety, by reference.

In some embodiments, the polymer coating includes one or more anionic polymers. Anionic polymers may be useful for ion exchange chromatography. Example of suitable anionic polymers include, but are not limited to poly(styrenesulfonic acid, sodium salt), poly(acrylic acid), poly(methacrylic acid), derivatives of these, and/or combinations of these. While the polymer coating may be suitable for separating components of a mobile phase, uncoated, exposed surfaces of the core particles and/or shell particles (e.g., diamond core and shell particles) may be functionalized for separating components of a mobile phase as an alternative to or in addition to using the polymer coating.

### II. Methods for Making Porous Composite Particulate Materials

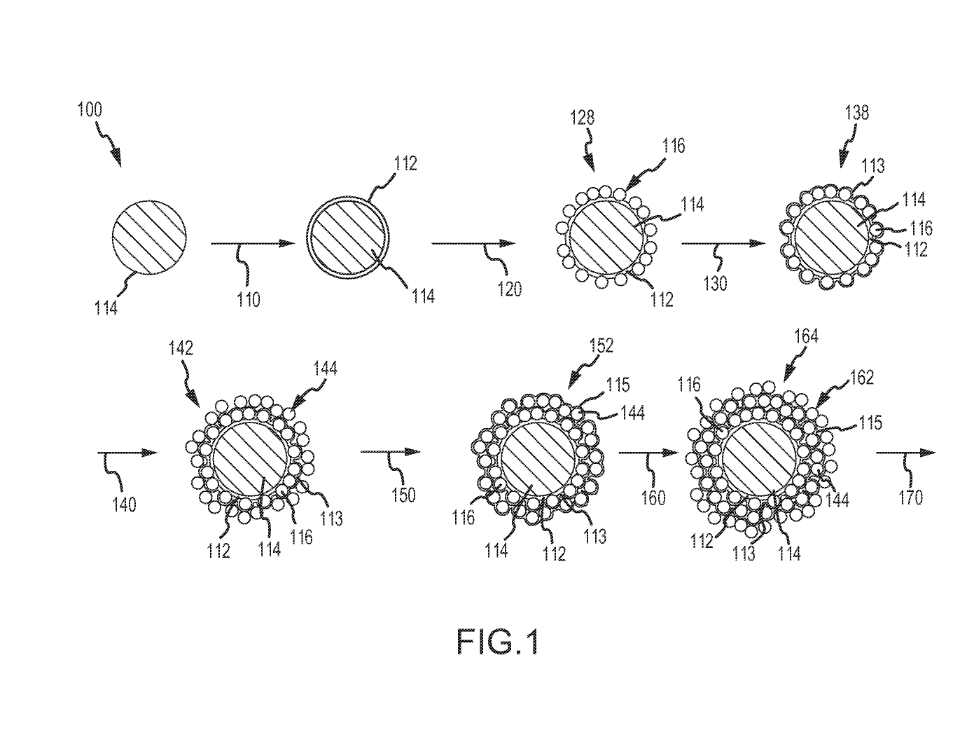

Reference is now made to FIG. 1 which illustrates a schematic flow diagram 100 of an embodiment of a method for making a porous composite particulate material from core particles, shell particles, and polymer material. FIG. 1 is a schematic illustration and does not necessarily represent the actual shape or sizes of the acid-base-resistant core particles and/or acid-base-resistant shell particles. Moreover, FIG. 1 illustrates a method for forming a single composite particle, and the porous composite particulate materials disclosed herein include a plurality of such composite particles.

In step 110, a plurality of acid-base-resistant core particles 114 are immersed in a polymeric material that coats and at least partially surrounds each core particle 114 with a respective polymer coating 112. In step 120, a first portion of acid-base-resistant shell particles are adhered to each core particle 114 to form a first porous shell layer 116 of shell particles. The shell particles adhere to the core particles 114 via the polymer coating 112. The thickness and composition of polymer coating 112 may be any thickness that is sufficient so that the shell particles adhere to the core particles 114. The thickness of the polymer coating 112 is typically sufficiently sized so that the polymer does not fill all the voids between adjacent shell particles of the first porous shell layer 116. Maintaining a relatively thin coating may help to provide a desired surface area. In an embodiment, the thickness of the polymer coating 112 may be about 0.1 nm to about 1 μm thick, about 1 nm to about 1 μm, or about 5 nm to about 100 nm. In an embodiment, the thickness of the polymer coating is less than the average diameter of the shell particles, more specifically the thickness is less than about half the diameter of the shell particles, and even more specifically less than one-fourth the diameter of the shell particles. The polymer coating 112 may be cured or otherwise chemically modified in step 120 or in subsequent steps, as described more fully below.

In an embodiment, more than one layer of shell particles may be deposited at a time on the core particle. The number of layers typically depends on the size of the particle and the desired thickness of the previous polymer layer.

The portion of shell particles may be applied to each core particle 114 by suspending the shell particles in a solvent and immersing the coated core particles 114 in the suspension of shell particles or, alternatively, the suspension of shell particles may be caused to flow over the core particles 114. Any solvent suitable for suspending the core particles and/or the shell particles may be used. In an embodiment, the core particles and/or the shell particles may be suspended in water. The coating of shell particles on the coated core particles 114 yields intermediate composite particles 128 having rough surfaces. The rough surface includes voids (i.e., recesses in the surface) between the individual shell particles of the first porous shell layer 116.

A plurality of the intermediate composite particles 128 may be used as a final product if desired and/or cross-linked to improve mechanical stability. However, substantially increased surface area may be achieved by repeating steps 110 and 120 to yield intermediate composite particles with increasing numbers of porous shell layers. As shown in step 130, a polymer coating 113 may be applied to the surface of the intermediate composite particle 128 to coat the shell particles of the first porous shell layer 116. The polymer coating 113 may be made from the same or a different polymeric material than the polymeric coating 112 used in step 110.

The thickness of the polymer coating 113 is typically sufficiently sized so that the polymer does not fill all the voids between adjacent shell particles of the first porous shell layer 116. In step 140, a second portion of the shell particles may be applied to intermediate composite particle 138 to yield second intermediate composite particles 142 each having a second porous shell layer 144 of shell particles bonded to the first porous shell layer 116.

In step 150, yet a third polymer coating 115 may be coated on intermediate composite particle 144 to yield intermediate particles 152, with the shell particles of the second porous shell layer 144 being coated. The polymer coating 115 may be made from the same or a different polymeric material than the polymeric coatings 112 or 113 used in steps 110 or 130. The thickness of the polymer coating 115 is typically sufficiently sized so that the polymer does not fill all the voids between adjacent shell particles of the second porous shell layer 144. In step 160, a third portion of shell particles may be adhered to the second porous shell layer 144 of intermediate particles 152 to yield intermediate composite particles 164 having a third porous shell layer 162 of shell particles.

The porous shell layers 116, 144, and 162 may have differently or similarly sized shell particles. Also, the shell particles in the different layers may have a different composition and/or be bonded using different compositions of polymer. The different shell particles, core particles, and polymers may be selected from any combination of the components described herein or components known in the art that are similar and/or provide similar function.

The method of adding additional porous shell layers may be continued until a desired number of porous shell layers and/or a desired surface area is achieved for the composite particles. In an embodiment, the method of forming porous shell layers may be repeated at least 5 times, more specifically at least about 10 times, or even more specifically at least 20 times to yield composite particles having 5, 10, or 20 porous shell layers, respectively. This method continues until the desired number of porous shell layers is achieved. In an embodiment, the number of porous shell layers is at least about 3, more specifically at least about 5, even more specifically at least about 10, yet even more specifically at least 20, and most specifically at least 50.

The shell particles, core particles, and/or composite particles may each be completely or partially coated with the polymer coating. In many cases, the polymer coating is applied using immersion, which tends to apply a relatively even coating around an entire particle. However, in some embodiments, one or more of the acid-base-resistant particles may only be partially coated with a sufficient polymer coating to adhere to other particles. In addition, the application of the shell particles may be asymmetric so as to create asymmetric composite particles.

Once the polymer has been attached to the surface of the core particles, there are numerous chemical reactions that may be performed, including cross-linking and curing. The cross-linking and/or curing may be carried out separately at any of the steps described in method 100. In an embodiment, curing may be performed for each step that results in the formation of a porous shell layer. In an embodiment, cross-linking is carried out as a final step 170. However, the step 170 is optional and embodiments also include the use of polymers that do not require curing and/or cross-linking.

In embodiments where curing and/or cross-linking is performed, the polymer coating may be cured and/or cross linked using any suitable technique such as thermal curing and/or radiation curing such as curing using infrared or ultraviolet curing lights. Curing may increase the physical and/or chemical stability of the polymer coating. For example, curing may increase the stability of the polymer coating when exposed to harsh conditions, such as high and/or low pH solutions, which may allow a stationary phase including the porous composite particulate material to be cleaned and/or otherwise used under harsh conditions. Some porous composite particulate materials described herein may be used in combination with strong solvents, high pH conditions, and/or low pH conditions. The ability to clean a column under harsh conditions may enable reuse of a previously contaminated stationary phase. In at least one embodiment, curing may cause amide linkage to form between various compounds in the polymer coating. Additionally, curing may cause amide or other linkages to form between various chemical moieties in the polymer coating and the surface of the acid-base-resistant particles.

In additional embodiments, a polymer in the coating may be allowed to react with another compound in the coating before, during, and/or after depositing the coating on the acid-base-resistant particles to increase the molecular weight of the coating. Increasing the molecular weight of the polymer may be advantageous in that the higher molecular weight coating may have increased stability in a variety of conditions.

Surprisingly, in an embodiment, the polymeric material may be applied to the core particles and/or the shell particles as a neutral polymer. The neutral polymers are able to encapsulate and hold the particles together without ionic interactions between the polymer and the particles. However, in some embodiments, a neutral polymer, such as PAAm, may bind through ionic interactions.

In additional embodiments, the coating and/or at least a polymeric compound forming the coating may be cross-linked during a curing process, such as a thermal and/or pressure-induced curing process, as described above. Additionally, the curing of the coating and/or at least a polymeric compound forming the coating, may be cross linked by exposing the coating to radiation. Cross-linking may cause stable bonds to form with amine groups and/or other chemical moieties in a polymeric compound in the coating, thereby increasing the stability of coating. Additionally, cross-linking compounds in the coating using compounds having epoxy groups may produce hydroxyl groups in and/or on the coating, resulting in a change in chemical characteristics of the coating and providing potential reactive sites on the coating. In an embodiment, the cross-linking produces a carbon-nitrogen bond, which has been found to work well for bonding together the relatively inert core and shell particles of the composite materials disclosed herein.

In certain embodiments, a cross-linking agent having at least two functional bonding sites may be used to effect cross-linking of at least a portion of the coating and/or at least a polymeric compound forming the coating. For example, a cross-linking agent may comprise a diepoxide compound having at least two epoxide groups, each of which may bond with an amine group. A cross-linking agent having at least two functional bonding sites may bond with at least one amine group on at least two or more polymeric molecules and/or compounds. In an additional embodiment, a cross-linking agent having at least two functional bonding sites may bond with at least one amine group on at least two separate sites on a single polymeric molecule. Additionally, a cross-linking agent having at least two functional bonding sites may bind to a polymeric compound forming the coating at only one of the at least two functional binding sites.

Examples of cross-linking agents suitable for cross-linking the polymer coating and/or at least a polymeric compound forming the polymer coating may include any type of compound containing two or more amine reactive functional groups, including, for example, diisocyanates, diisothiocyanates, dihalides, diglycidyl ethers, diepoxides, dianhydrides, dialdehydes, diacrylates, dimethacrylates, dimethylesters, di- and/or triacrylates, di- and/or trimethacrylates, and/or other diesters. In at least one embodiment, acrylates and/or methacrylates may react with an amine by Michael addition.

In addition, suitable cross-linking agents may include, without limitation, 1,2,5,6-diepoxycyclooctane, phenylenediisothiocyanate, 1,4-diisocyanatobutane, 1,3-phenylene diisocyanate, 1,6-diisocyanatohexane, isophorone diisocyanate, diethylene glycol diglycidyl ether, 1,4-butanediol diglycidyl ether, bisphenol A diglycidyl ether, poly(ethylene glycol) diglycidyl ether, poly(propylene glycol) diglycidyl ether, octanedioic acid dichloride (suberic acid dichloride), phthaloyl dichloride, pyromellitic dianhydride, 1,3-butadiene diepoxide, p-phenylene diisothiocyanate, 1,4-dibromobutane, 1,6-diiodohexane, glutaraldehyde, 1,3-butanediol diacrylate, pentaerythritol triacrylate, pentaerythritol tetraacrylate, dipentaerythritol pentaacrylate, 1,6-hexanediol dimethacrylate, and/or propoxylated (3) glyceryl triacrylate. Cross-linking agents may additionally comprise at least one functional group suitable for bonding with non-amine functional groups that may be present on polymers in the coating disclosed herein. The cross-linking agents may also include two or more functional groups, which may be the same or different. For example, the cross-linking agent may include molecules that have an acrylate and a methacrylate group, or a glycidyl group and a methacrylate group.

Generally, the polymer coating may be at least partially cross-linked. In an embodiment, the cross-linking exhibited by the polymer coating may be about 1% to about 99%, at least about 70%, about 55% to about 75%, about 75% to about 95%, at least about 85%, at least about 95%, or even at least about 99%. However, in some embodiments, the cross-linking may be less than about 99%, less than about 95%, or less than 85%, which may be useful so that the polymer coating exhibits a sufficient toughness to avoid cracking during use and/or handling. In some embodiments the crosslinking may be in a range from 1%-99%.

In an embodiment, an epoxide compound such as, 1,2,5,6-diepoxycyclooctane, may have at least one highly strained epoxide ring that may be reactive with various amine groups in the polymer coating. Various alcohols may be used as effective solvents for amine-epoxide reactions. Reaction of the at least one highly strained epoxide ring with an amine group in the coating may result in immobilization of hydrophobic cyclooctyl rings and hydrophilic hydroxyl groups in the coating, leading to the formation of a mixed-mode stationary phase in the coating. This type of mixed-mode stationary phase may be employed for various uses, including, for example, retention of proteins and small molecules such as drugs under reverse phase and/or normal conditions in an SPE column.

The amine group is an extremely versatile chemical reagent with a rich chemistry. Information about some of these reactions may be found in U.S. patent application Ser. No. 12/040,638 filed on 29 Feb. 2008, entitled, “Functionalized Diamond Particles And Methods For Preparing The Same,” which is hereby incorporated herein, in its entirety, by this reference.

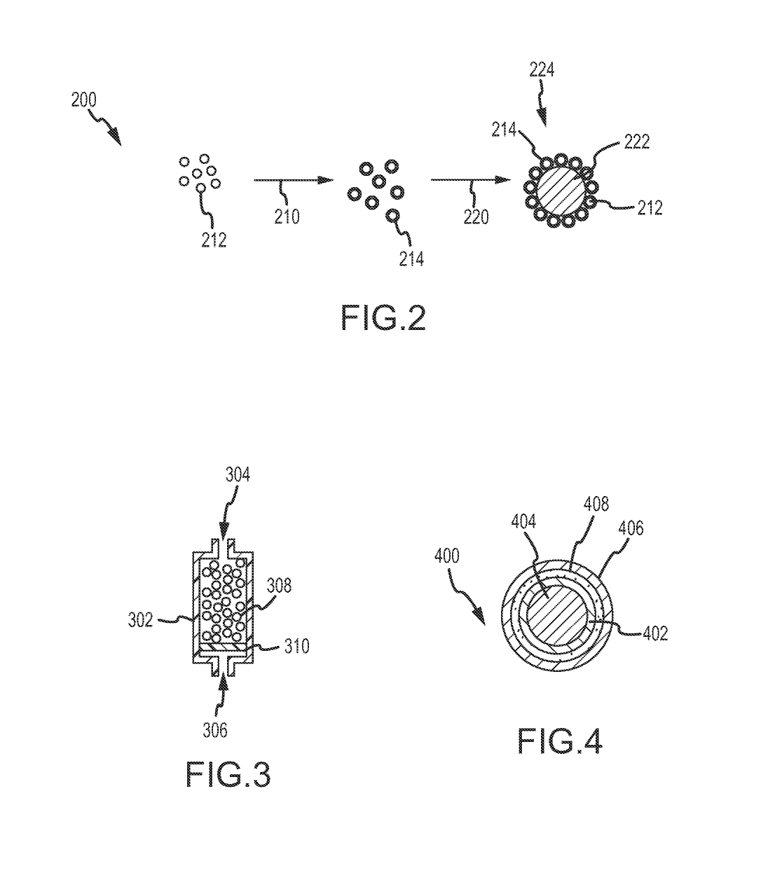

FIG. 2 describes another embodiment of a method 200 in which all or a portion of the acid-base-resistant shell particles are coated with polymer material prior to being adhered to the core particles or to each other (e.g., in a layer-by-layer process described above). In method 200, step 210 includes applying a polymer coating to acid-base-resistant shell particles to yield coated particles 214. In step 220, acid-base-resistant core particles 222 are mixed with the shell particles 212 using any suitable mixing process. The polymer coating on the coated shell particles 214 bonds the shell particles 212 to the core particles 222 to yield an intermediate composite particle 224. Additional layers of shell particles may be bonded to intermediate composite particle 224 by adding a second portion of coated shell particles 214 or alternatively by coating the composite particles 224 with polymer material and shell particles as described in steps 110 and 120. The method 200 may also include additional curing and/or cross-linking steps as described above with regard to the method 100.

In an embodiment, the porous composite particulate material may include a body of bonded composite particles. The body may be formed by forming a bed of coated intermediate composite particles (e.g., composite particles 224) and polymerizing or otherwise joining the individual composite particles together to form a coherent body. Forming a body of bonded composite particles may allow the individual particles to maintain their integrity.

In other embodiments, some of the core particles may be coated with polymer material and some of the core particles may be uncoated. Also some of the shell particles may be coated with polymer material and some of the shell particles may be uncoated. In such an embodiment, the coated/uncoated core particles may be mixed together with the coated/uncoated shell particles to form a plurality of composite particles.

FIG. 3 describes a method for forming a body of bonded composite particles in vessel according to another embodiment. In this embodiment, a vessel 302 is provided that includes an inlet 304 and an outlet 306. A plurality of core particles are positioned within the vessel 302 to form a particle bed 308. The core particles may be retained in the vessel by a frit 310. In a first step, the vessel 302 is at least partially filled to form the bed 308. In a second step, the particles in the bed 308 are at least partially coated with a layer of polymer. In a third step, a suspension of shell particles is caused to flow through the bed 308, such as through voids between adjacent core particles. The shell particles bond to the core particles through the layer of polymer. Additional porous shell layers may be added as described above with regard to FIGS. 1 and 2. The body may be formed by curing and/or cross-linking the intermediate composite particles so-formed while packed in the vessel as a bed. The bonded composite particles have improved structural integrity, which may help prevent shell particles from being freed during use of the porous composite particulate material in chromatography.

### III. Porous Composite Particulate Materials

The porous composite particulate materials described herein provide desired sizes, porosity, surface areas, and chemical stability suitable for chromatography and SPE techniques. When used in chromatography and SPE, high-resolution separation may be achieved with relatively low back pressure,

The porous composite particulate materials include a plurality of composite particles, with each composite particle including a core particle at least partially surrounded by one or more layers of shell particles. The shell particles are bonded to the core particles by a polymer coating. The shell particles may be made from the acid-base-resistant materials described above, including but not limited to diamond particles, graphitic carbon, silicon carbide, boron nitride, tungsten carbide, niobium carbide, a binderless carbide (e.g., binderless tungsten carbide), zirconia, noble metals, acid-base stable highly cross-linked polymers, titania, alumina, thoria, and combinations thereof. At least a number of the core particles include at least one exterior layer of non-diamond carbon. The core particles may be made from a particle including at least one exterior layer of non-diamond carbon, such as an at least partially carbonized polymeric particle. The porous composite particulate material may also have any combination of polymers described above. However, in an embodiment, the polymer coating that bonds the core particles to the shell particles and/or the shell particles to themselves is an amine polymer.

The composite particles may be provided in the form of finely divided discrete particles (e.g., a powder). Alternatively, the composite particles may be provided as a body of bonded composite particles. When the composite particles are provides as a body of bonded composite particles, the body may exhibit dimensions suitable for use in a separation apparatus, such as, but not limited to, separation devices used in HPLC.

In an embodiment, the composite particles have a particle size in a range from about 0.5 (or lower) μm to 500 μm, more specifically about 1 μm to 200 μm, or even more specifically in a range from about 1 μm to about 150 μm. In an embodiment, the composite particles have a particle size in a range from about 1 μm to about 10 μm, or more specifically about 1.5 μm to about 7 μm. This particle range may be particularly useful for HPLC applications and the like. In another embodiment, the composite particles can have a particle size can be in a range from about 5 μm to about 500 μm, or more specifically in a range from about 10 μm to about 150 μm. This larger particle range may be more suitable for use in solid phase extraction applications and the like.

The composite particles may include a desired surface area. The surface area may depend on core and shell particle size, number of porous shell layers, and particle geometry. However, the surface area of the composite particles is higher than a similarly sized core particle due to the additional surface area provided by the shell particles. In an embodiment, the surface area may be measured using the Brunauer Emmett and Teller (“BET”) technique and is in a range from 1-500 m²/g for composite particles having a particle size in a range from about 1 μm to 500 μm, more specifically in a range from 25-300 m²/g, or even more specifically 50-200 m²/g. In an embodiment, the composite particles have a particle size in a range from about 0.5 μm to 10 μm may have a surface area in a range from about 10-500 m²/g, more specifically in a range from 25-200 m²/g, and even more specifically in a range from 25-60 m²/g. In another embodiment, composite particles having a particle size of at least about 0.5 μm (e.g., about 10 μm to 250 μm) may have a surface area of at least about 5 m²/g (e.g., about 5-200 m²/g, more specifically about 10-100 m²/g, or even more specifically about 50-150 m²/g). In yet another embodiment, composite particles having a particle size in a range from about 250 μm to about 500 μm may have a surface area at least about 5 m²/g, and even more specifically at least about 10 m²/g for composite particles with a particle size in a range from about 250 μm to about 500 μm.

In a more detailed embodiment, a composite particle including a non-diamond core particle having a size of about 2.5 μm to about 5 μm and 1-50 porous shell layers of diamond shell particles having a particle size of about 5 nm to about 50 nm may have a surface area of about 1 m²/g to about 60 m²/g. In a more specific embodiment, a composite particle including a non-diamond core particle having a size of about 2.5 μm and 10-50 porous shell layers of diamond shell particles having a particle size of about 5 nm to about 10 nm may have a surface area of about 14 m²/g to about 60 m²/g. In another more specific embodiment, a composite particle including a non-diamond core particle having a size of about 5 μm and 10-50 porous shell layers of diamond shell particles having a particle size of about 5 nm to about 10 nm may have a surface area of about 7 m²/g to about 33 m²/g.

FIG. 4 illustrates a composite particle that includes at least a bilayer of polymer according to another embodiment. A bilayer of polymer may be constructed from a first polymer coating 402 on an acid-base-resistant core particle 404. The polymer coating 402 may be formed using steps 110 and 120 as described above. A bilayer is formed by adding a functional polymer layer 406 and a second polymer coating layer 408. The polymer layers 402 and 408 are binding layers selected for bonding the shell particles to the core particles and/or the shell particles to the shell particles. The functional layer 406 is a polymeric layer that imparts a desired functionality to the composite particle. The polymers that are used to make the functional layer 406 may be selected from the polymers mentioned above that are useful for forming layers 402 and 408. However, the formation of a bilayer allows the selection of two or more different polymers to form the composite thereby allowing the different polymer layers to be optimized for different purposes. Typically, the layers 402 and 408 are selected for bonding polymers together and the functional polymer layer 406 is selected for providing a separate function such as, but not limited to properties related to separation efficiency. In an embodiment, the functional polymer layer 406 may be an anionic polymer.

In some embodiments, an additional particulate component may be embedded in the porous shell layers of the shell particles. The additional particulate component may be any organic or inorganic material that provides a desired property to the porous composite particulate material. In an embodiment, the additional component may be initially included in the manufacture of the composite particles but then removed. For example, the porous shell layers may include silica particles that exhibit a selectivity to be removed over more acid-base-resistant particles, such as diamond, graphite, or boron nitride shell particles. This method may allow a composite particle to be formed with particular structural features. Alternatively, the additional component may be included with the purpose of removing or eluding out the component during use. For example, the additional component may be configured to elute out over time in the presence of a mobile phase.

In an embodiment, the additional component may be a particle that has affinity for a drug or other chemical reagent. In an embodiment, the additional component may include a catalytic reagent. The additional component may be included in the core particles and/or the layers of shell particles.

### IV. Separation Apparatuses and Methods

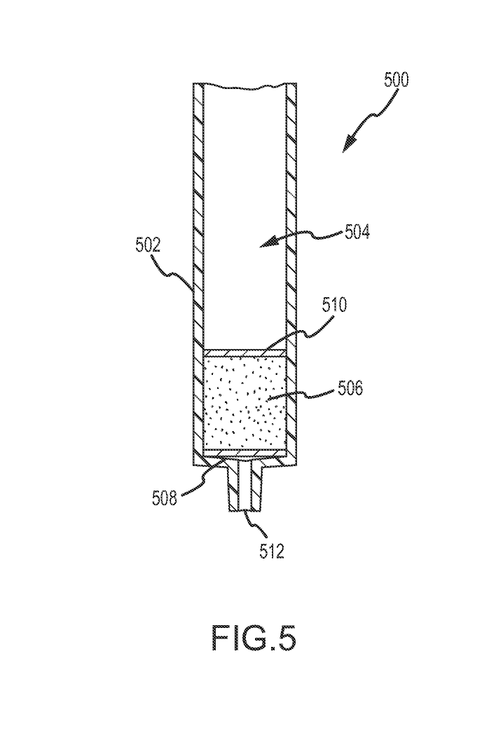

FIG. 5 is a cross-sectional view of a separation apparatus 500 according to an embodiment. The separation apparatus 500 may include a column 502 defining a reservoir 504. A porous body 506 (e.g., a porous composite bed, porous disk, other porous mass, etc.) may be disposed within at least a portion of the reservoir 504 of the column 502. The porous body 506 may comprise any of the porous composite particulate materials disclosed herein in bonded or powder form. The porous body 506 is porous so that a mobile phase may flow therethrough. In various embodiments, a frit 508 and/or a frit 510 may be disposed in column 502 on either side of porous body 506. The frits 508 and 510 may comprise any suitable material that allows passage of a mobile phase and any solutes present in the mobile phase, while preventing passage of the composite particulate material present in porous body 506. Examples of materials used to form the frits 508 and 510 include, without limitation, glass, polypropylene, polyethylene, stainless steel, titanium, and/or polytetrafluoroethylene.

The column 502 may comprise any type of column or other device suitable for use in separation processes such as chromatography and solid phase extraction processes. Examples of the column 502 include, without limitation, chromatographic and solid phase extraction columns, tubes, syringes, cartridges (e.g., in-line cartridges), and plate containing multiple extraction wells (e.g., 96-well plates). The reservoir 504 may be defined within an interior portion of the column 502. The reservoir 504 may permit passage of various materials, including various solutions and solvents used in chromatographic and solid-phase extraction processes.

The porous body 506 may be disposed within at least a portion of reservoir 504 of the column 502 so that various solutions and solvents introduced into the column 502 contact at least a portion of the porous body 506. The porous body 506 may comprise a plurality of substantially non-porous particles in addition to the composite porous material.

In certain embodiments, fits, such as glass frits, may be positioned within the reservoir 504 to hold porous body 506 in place, while allowing passage of various materials such as solutions and solvents. In some embodiments, a frit may not be necessary, such as the body of bonded-together composite particles as described above with reference to FIG. 4.

In an embodiment, the separation apparatus 500 is used to separate two or more components in a mobile phase by causing the mobile phase to flow through the porous body 506. The mobile phase is introduced through an inlet and caused to flow through the porous body 506 and the separated components may be recovered from the outlet 512.

In an embodiment, the mobile phase includes concentrated organic solvents, buffers, acids, or bases. In an embodiment, the mobile phase includes a concentrated acid with a pH less than about 3, more specifically less than about 2. In another embodiment, the mobile phase includes a base with a pH greater than about 9, more specifically greater than about 11, and even more particularly greater than 12.

In an embodiment, the separation apparatus 500 is washed between a plurality of different runs where samples of mixed components are separated. In an embodiment, the washing may be performed with water. In another embodiment, a harsh cleaning solvent is used. In this embodiment, the harsh cleaning solvent may be a concentrated organic solvent and/or a strong acid or base. In an embodiment, the cleaning solvent has a pH less than about 3, more specifically less than about 2. In another embodiment, the cleaning solvent has a pH greater than about 10, more specifically greater than about 12, and even more particularly greater than 13.

### V. Examples

The following examples are for illustrative purposes only and are not meant to be limiting with regards to the scope of the specification or the appended claims.

### Examples 1-5

### Non-Diamond Carbonized Core Particle and Layer-by-Layer Deposition Thereon

A. Procedure

Examples 1-5 demonstrated a method of forming porous composite particulate materials using non-diamond carbonized core particles, PAAm, and nanodiamond shell particles

Examples 1-5 are made with two different starting materials. The first starting material is PDVB particles that were formed by the inventors. Materials made by the first starting material will be prefaced with “in-house.” The second starting material were 5 μm PDVB particles that are commercially available from Sepax Technologies, Newark Del. Materials made by the second starting material will be prefaced with “commercial.”

The in-house PDVB particles were prepared in two steps. The first step followed Li, K., Stover, H. D. H., Journal of Polymer Science: Part A: Polymer Chemistry 1993, 31, 3257-3263 and Bai, F., Yang, X., Huang, W., Macromolecules 2004, 37, 9746-9752, the disclosures of both of which are incorporated herein in their entirety by this reference. The in-house PDVB particles were initially formed using 2% azobisisobtyronitrile (“AIBN”) (relative to weight of divinylbenzene (“DVB”) and previously recrystallized from methanol) and 2% DVB (relative to total volume of dry acetonitrile (“ACN”)). The initially formed in-house PDVB particles exhibited a particle size of about 3.0-3.7 μm. The initially formed in-house PDVB particles were rinsed with tetrahydrofuram, acetone, and diethyl ether to remove any unreacted monomer, soluble polymer, and/or residuals of the initiator. The rinsed PDVB particles were then filtered on a 0.45 μm membrane filter made by Pall Life Sciences, Port Washington, N.Y., and dried at room temperature under vacuum overnight.

The second step of the in-house PDVB particle formation followed Li, W.-H., Stover, H. D. H., Macromolecules 2000, 33, 4354-4360, the disclosure of which is incorporated herein, in its entirety, by this reference. An 800 mL reaction solution of 2% AIBN and 2% DVB was prepared as in the first stage of the in-house PDVB particle formation process. The initially formed in-house PDVB particles obtained from the first stage of the in-house PDVB particle formation process were divided equally by weight into four hybridization tubes. About 200 mL of the 2% AIBN and 2% DVB solution was then added to each tube for an additional polymerization. The final in-house PDVB particles exhibited a particle size of 4.0-4.8 μm. The final in-house PDVB particles were filtered and dried as in step 1.

The in-house and commercial PDVB particles were air oxidized and carbonized to form non-diamond carbonized core particles according to the procedure of Li, L., Song, H., Chen, X., Materials Letters 2008, 62, 179-182, which was previously incorporated by reference. The in-house PDVB particles were carbonized at 700° C. to form in-house non-diamond carbonized core particles. The commercial PDVB particles were carbonized at 900° C. to form commercial non-diamond carbonized core particles, or carbonized at 1050° C. in the case of the column used to separate the essential oils. The purpose of the higher carbonization temperature was to reduce the particle size of the non-diamond carbonized core particles. The particle diameter of the in-house non-diamond carbonized core particles was 2.8-3.3 μm after carbonization. The particle diameter of the commercial non-diamond carbonized core particles was about 3.6 μm after carbonization.

After carbonization, the particles were again oxidized. Oxidation of both non-diamond carbonized core particles was preformed because the hydrophobicity of both types of non-diamond carbonized core particles prevented their suspension in the solvents used for the deposition of the polymer and nanodiamond shell particles. Accordingly, it was convenient to oxidize the surfaces of the particles to increase their surface free energy/hydrophilicity/dispersability. The oxidation of both types of PDVB particles was performed using two different oxidation reagents: nitric acid and piranha solution (70% H₂SO₄:30% concentrated H₂O₂). The HNO₃ oxidation process followed the reports of Moreno-Castilla, C., Ferro-Garcia, M. A., Joly, J. P., Bautista-Toledo, I., F. Carrasco-Marin, Rivera-Utrilla, J., Langmuir 1995, 11, 4386-4392 and El-Hendawy, A.-N. A., Carbon 2003, 41, 713-722, the disclosure of which is incorporated herein, in its entirety, by this reference. The piranha solution process followed Saini, G., Jensen, D. S., Wiest, L. A., Vail, M. A., Dadson, A., Lee, M. L., V., S., Linford, M. R., Analytical Chemistry 2010, 82, 4448-4456, the disclosure of which is incorporated herein, in its entirety, by this reference. For the HNO₃ and piranha solution processes, the ratio of carbonized PDVB to acid solution was about 3 weight %. The HNO₃ process was carried out in 68-70% HNO₃ at 60° C. for 24 hr. The piranha solution process was carried out at 100° C. for 1 hr. After the oxidation processes, the solutions were diluted with Millipore water and both non-diamond carbonized core particles were captured by filtration through a 0.22 μm nitrocellulose membrane. The oxidized non-diamond carbonized core particles were then dried under vacuum overnight.

Next, the porous composite particulate materials were formed using each type of non-diamond carbonized core particles. Polymer, PAAm, and shell particles were applied to both types of non-diamond carbonized core particles using a method similar to FIG. 1. After each deposition of PAAm, the non-diamond carbonized core particles were sonicated with a probe sonicator (Model 450, Branson Ultrasonics Corporation, Danbury, Conn.) for 2 min at 25% output power as disclosed in U.S. application Ser. No. 13/297,052 filed on 15 Nov. 2011 which is incorporated herein in its entirety by this reference. The non-diamond carbonized core particles were filtered through a 40 μm sieve to remove any large agglomerates. This process was repeated as many times as desired.

Functionalization and crosslinking of both types of non-diamond carbonized core particles was performed as a single step as described in Wiest, L. A., Jensen, D. S., Hung, C.-H., Olsen, R. E., Davis, R. C., Vail, M. A., Dadson, A. E., Nesterenko, P. N., Linford, M. R., Analytical Chemistry 2011, 83, 5488-5501, the disclosure of which is incorporated herein, in its entirety, by this reference. Both types of non-diamond carbonized core particles were then filtered through a 40 μm sieve to remove any large agglomerates introduced by the functionalization process.

Column packing was performed with a Haskel air-driven fluid pump (available from Haskel International, Burbank, Calif.) following the procedure disclosed in Wiest et al. In particular, the pressure was increased 1000 psi every 5 min up to its final pressure, e.g., 7000 psi. After reaching the maximum pressure, column packing continued until 90 mL of packing solvent had passed through the column. After column packing, the columns were rinsed with methanol for 20 minutes and then tested using mobile phase of 40:60:0.1 H2O:ACN:triethylamine (“TEA”) (v:v:v), at 0.7 mL/min at 35° C.

As referred to hereafter, Examples 1-3 are commercial porous composite particulate materials. Example 4 is an in-house porous composite particulate material. Example 5 is similar to Example 4 except that Example 5 was sedimented instead of being sieved. Examples 1-5 were oxidized using HNO₃.

B. Results

X-ray photoelectron spectroscopy (“XPS”) was used to analyze the oxygen and carbon ratios of Examples 1-5 after the second oxidation process. Increased oxygen and carbon ratios (i.e., increased oxidation) decreased the hydrophobicity of Examples 1-5. XPS, which probes about 10 nm of a surface of a material, had given an oxygen to carbon (O/C) ratio of about 0.10 for Examples 1-5 before oxidation. XPS O/C ratio increased substantially to about 0.24 after treating the carbonized PDVB particles with nitric acid. After oxidation, the XPS C is narrow scan of the Examples showed more signal at higher binding energies, which is consistent with increased oxidation of the particle surfaces. Oxidation in piranha solution (a mixture of concentrated sulfuric acid and concentrated hydrogen peroxide), which was used to clean the core diamond particles in analogous core-shell particles for solid phase extraction, also raised the XPS O/C ratios of the carbon particles. XPS also confirmed the deposition of PAAm onto oxidized and unoxidized carbonized core particles. However, XPS suggests greater deposition of PAAm, as evidenced by a larger N 1s signal for Examples 1-5.

Scanning Electron Microscopy (“SEM”) was used to analyze the growth of the polymer and shell particles on Examples 1-5. SEM images of shell growth on both types of particles after deposition of 5, 15, and 25 bilayers of PAAm and nanodiamond showed that a porous nanodiamond/polymer composite coating was growing on Examples 1-5. The growth on the non-diamond carbonized core particles was also monitored after each PAAm/nanodiamond deposition cycle. Overall there appeared to be relatively consistent growth nanodiamond/polymer composite coating (an increase in diameter of about 40 nm per bilayer). However, there also appeared to be regions of limited growth and others of more accelerated growth. The particle size distribution appears to remain nearly constant for the first 10 bilayers, after which it appears to increase fairly steadily.

Particle size distribution (“PSD”) measurements were performed after deposition of 30 bilayers of the nanodiamond/polymer composite coating on Examples 10-14. Measurements were taken both before and after agglomerates were removed. PSD showed that after 30 deposition of the nanodiamond/polymer composite coating on the in-house and commercial cores, the nano-diamond carbonized core particles' diameters had increased to about 3.3 and 4.0 μm, respectively. The increase in the nano-diamond carbonized core particles' diameter (about 0.4-0.5 μm) was nearly the same for both types of nano-diamond carbonized core particles. Examples 10-12 showed tighter PSDs after sieving than Example 13 (d90/d10 of 1.36 vs. 1.42).

Next, the back pressures of Examples 1-5 were measured. Examples 1-4 showed better back pressures than Example 5. For example, Example 4 showed a back pressure of 1271 psi while Example 5 had a back pressure of 2329 psi. Also, Examples 1-3 showed a lower backpressure (729 psi) than Example 4 (1271 psi). The difference in the back pressure between the two porous composite particulate materials is caused by the large size of the commercial PDVB carbonized particles.

The reproducibility of the functionalization and packing procedures was evaluated. Examples 1-3 were packed under identical conditions. Reproducible chromatograms of a series of alkyl benzenes were separated using Examples 1-3. The efficiencies, retention factors (k), peak asymmetries and column back pressures where measured. The results are shown in Table 1. In these separations, efficiencies for decyl benzene range from 91,000 to 96,000 N/m, retention factors (k) are very similar (% RSD of 1.56), peak asymmetries (Asym10%) are low and similar, and column back pressures are also low and similar.

TABLE 1
Mobile phase: 40:60:0.1 H₂O:ACN:TEA (v:v:v),
flow rate: 0.7 mL/min, 35° C.

| Column ID | N/m | k | Asym10% | Psi |
|---|---|---|---|---|
| Example 1 | 91,000 | 8.66 | 1.11 | 729 |
| Example 2 | 93,000 | 8.91 | 1.16 | 659 |
| Example 3 | 96,000 | 8.69 | 1.17 | 659 |
| Average ± SD | 93,000 ± 3000 | 8.75 ± 0.14 | 1.15 ± 0.03 | 682 ± 40 |
| % RSD | 3.2 | 1.6 | 2.6 | 5.9 |

Plate height, H, vs. mobile phase velocity, v, curves were generated to determine the A-, B-, and C-terms of the van Deemter equation for the columns using Examples 10-14. This work was performed on a UPLC system to minimize extra column contributions due to band broadening. Kirkland et al. noted that high-quality columns show reduced plate heights in the range of 2-2.5 with USP Tailing Factors of less than 1.2 for non-polar analytes. Examples 1-3 had an h between 2 and 2.5 with tailing factors of about 1.0 to 1.4 for alkylbenzene analytes. Example 5 had the lowest efficiency in Table 2. As noted, the particles in this column had been sedimented, but not sieved as were the particles for the other columns in Table 2. The reduced terms a and b are especially low for Examples 1-3. However, with sieving, the c term is comparable for the in-house and commercial porous composite material.

TABLE 2

| | | | | | | | Optimal | | | | | |
|---|---|---|---|---|---|---|---|---|---|---|---|---|
| | | | | | | | Flow Rate | | | | | |
| Column ID | dp (μm) | d90/d10^{b)} | A | B | C | H | (mL/min) | a | b | C | h | N/m |
| In-house, | about3.3^{a)} | N/A^{c)} | 6.06 | 1.80 | 4.38 | 11.57 | 0.8 | 1.84 | 0.55 | 1.33 | 3.51 | 86,000 |
| Not Sieved | | | | | | | | | | | | |
| In-house, | about3.3 | 1.42 | 5.58 | 1.68 | 2.77 | 9.88 | 0.7 | 1.69 | 0.51 | 0.84 | 2.99 | 101,000 |
| Sieved | | | | | | | | | | | | |
| Commercial | about4.0 | 1.36 | 4.97 | 1.31 | 3.78 | 9.43 | 0.6 | 1.24 | 0.32 | 0.95 | 2.36 | 106,000 |
| Sieved #1 | | | | | | | | | | | | |
| Commercial, | about4.0 | 1.36 | 4.51 | 1.07 | 4.73 | 8.89 | 0.4 | 1.13 | 0.27 | 1.18 | 2.22 | 112,000 |
| Sieved #2 | | | | | | | | | | | | |
| Commercial, | about4.0 | 1.36 | 4.41 | 1.38 | 4.57 | 9.48 | 0.6 | 1.10 | 0.35 | 1.14 | 2.37 | 105,000 |
| Sieved #3 | | | | | | | | | | | | |

^{a)}Average diameter of isolated particles, excluding agglomerates.
^{b)}Data obtained from a PSD analyzer
^{c)}Data not available because of the presence of agglomerates.

### Example 6

### Thermal Stability of Non-Diamond Carbonized Core Particle

Example 6 is a porous composite particulate material formed from in-house PDVB particles similar to Example 4 except that Example 6 was oxidized in a piranha solution and was not sieved.

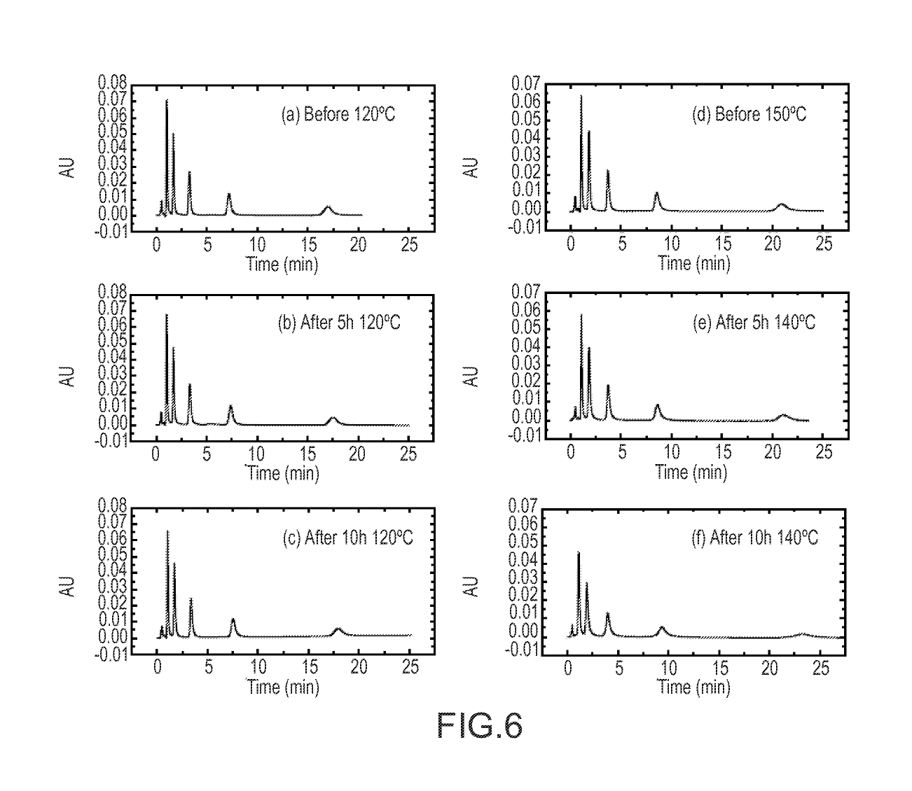

The stability of Example 6 in a column at various temperatures was tested and the chromatographs are shown in FIG. 6. FIG. 6 are chromatograms of an alkybenzene test mixture (ethyl-, butyl-, hexyl-, octyl-, and decylbenzene) taken at 35° C. with 60:40:0.1 H2O:ACN:TEA (pH 11.3) (v:v:v) at 0.7 mL/min before ((a) and (d)) and after ((b), (c), (e), and (f)) stability tests (5 hr each) 23 on a single column. The same mobile phase and conditions were used for the 120° C. purges. For the 140° C. purges, the mobile phase was 70:30:0.1 H2O:ACN:TEA (pH 11.3) (v:v:v) at 0.7 mL/min. The mobile phase was made up again for column testing before and after the 140° C. experiments, which accounts for the small shifts in retention.

Still referring to FIG. 6, chromatograms were taken before and after two heating cycles, each of which consisted of five hours of mobile phase flowing at the temperature in question. The chromatograms were performed at a pH of 11.3 and a temperature of either 120° C. or 140° C. Table 3, shown below, shows that there is about a 5% increase in retention and a 10% decrease in efficiency for some alkyl benzene analytes after the two heating cycles at 120° C. After two heating cycles at 140° C., there is about a 10% increase in retention and about a 25% loss in N/m. These results suggest that Example 6 is quite stable at 120° C. and pH 11.3, but that Example 6's performance begins to degrade at higher temperatures. However, it is noteworthy that in no case was a catastrophic decrease in Example 6 observed.

TABLE 3

| | | Mobile Phase | | | | | | |
|---|---|---|---|---|---|---|---|---|
| Heating | | (H₂O:ACN:TEA, | Flow rate | Temperature | k | k | N/m | N/m |
| cycle | pH | v:v:v) | (mL/min) | (° C.) | (Before) | (After) | (Before) | (After) |
| I | 11.3 | 60:40:0.1 | 0.7 | 120 | 34.4 | 35.5 | 90000 | 82000 |
| II | 11.3 | 60:40:0.1 | 0.7 | 120 | 37.8 | 36.2 | 86000 | 81000 |
| I | 11.3 | 70:30:0.1 | 0.7 | 140 | 42.5 | 41.5 | 80000 | 73000 |
| II | 11.3 | 70:30:0.1 | 0.7 | 140 | 41.5 | 46.6 | 73000 | 59000 |

A column that was packed using sieved commercial porous composite material was used to separate four essential oils: eucalyptus, lavender, melaleuca, and peppermint. Analytes were dissolved in ACN and directly injected. All separations were gradient elutions. In most cases peak shapes seemed quite good. Peak widths in the separations appear to be roughly constant, which is expected for gradient elution. As expected in the separation of complex mixtures, not all the components appear to be completely resolved.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method for manufacturing a porous composite particulate material, the method comprising:
providing a plurality of acid-base-resistant core particles, wherein a number of the plurality of acid-base-resistant core particles includes at least one exterior layer of non-diamond carbon;
providing a plurality of acid-base-resistant shell particles;
coating at least a portion of the plurality of acid-base-resistant core particles, at least a portion of the plurality of acid-base-resistant shell particles, or combinations thereof with polymer material;
adhering a portion of the plurality of acid-base-resistant shell particles to each of the plurality of acid-base-resistant core particles with the polymer material to form a plurality of composite particles; and
cross-linking the polymeric material.

3. The method of claim 1, wherein each of the number of the plurality of acid-base-resistant core particles includes about 70 volume % to about 90 volume % of the non-diamond carbon.

4. The method of claim 1, wherein each of the number of the plurality of acid-base-resistant core particles consists essentially of the non-diamond carbon.

5. The method of claim 1, wherein the non-diamond carbon includes graphitic carbon.

6. The method of claim 1, wherein cross-linking the polymeric material causes least about 55% to about 75% cross-linking in the polymeric material.

7. The method of claim 1, wherein the plurality of composite particles exhibits a particle size of at least about 0.5 μm and a surface area of at least about 5.0 m²/g.

8. The method of claim 1, wherein the plurality of acid-base-resistant core particles exhibits a particle size of at least an order of magnitude larger than the plurality of acid-base-resistant shell particles.

9. The method of claim 1, wherein the polymer material is coated on the at least a portion of the plurality of acid-base-resistant core particles before the act of adhering.

10. The method of claim 1, wherein the acts of coating and adhering include:
immersing the plurality of acid-base-resistant core particles in a polymer solution to form polymer-functionalized core particles;
immersing the polymer-functionalized core particles in a suspension of a first portion of the plurality of shell particles to yield a plurality of intermediate composite particles;
immersing the intermediate composite particles in a polymer solution to yield polymer-functionalized intermediate composite particles;
immersing the polymer-functionalized intermediate composite particles in a second portion of the plurality of acid-base-resistant shell particles to yield composite particles having a plurality of layers of shell particles; and
cross-linking the polymeric material.

11. The method of claim 1, wherein the plurality of acid-base-resistant shell particles comprise nanodiamond particles with a particle size of less than about 1 μm.

12. The method of claim 1, wherein the acts of coating and adhering comprise:
forming a bed of the plurality of acid-base-resistant core particles in a vessel;
flowing a liquid polymeric material through the bed to coat the plurality of acid-base-resistant core particles thereof with the polymer material; and
flowing the plurality of acid-base-resistant shell particles through the bed to adhere the portion of the plurality of acid-base-resistant shell particles to the each of the plurality of acid-base-resistant core particles.

13. The method of claim 1, further comprising carbonizing a carbon-containing material to form an acid-base-resistant core particle.

14. A porous composite particulate material, comprising:
a plurality of composite particles, each of the plurality of composite particles including:
an acid-base-resistant core particle including at least one exterior layer of non-diamond carbon;
a plurality of acid-base-resistant shell particles; and
a cross-linked polymeric layer bonding the plurality of shell particles to the acid-base-resistant core particle.

15. The porous composite particulate material of claim 14, wherein each of the number of the plurality of acid-base-resistant core particles includes about 70 volume % to about 90 volume % of the non-diamond carbon.

16. The porous composite particulate material of claim 14, wherein each of the number of the plurality of acid-base-resistant core particles consists essentially of the non-diamond carbon.

17. The porous composite particulate material of claim 14, wherein the non-diamond carbon includes graphitic carbon.

18. The porous composite particulate material of claim 14, wherein the at least one exterior layer of the non-diamond carbon defines a cladding layer.

19. The porous composite particulate material of claim 14, wherein cross-linking the polymeric material causes least about 55% to about 75% cross-linking in the polymeric material.

20. The porous composite particulate material of claim 14, wherein at least a portion of the plurality of acid-base-resistant shell particles includes at least one member selected from the group consisting of diamond, graphitic carbon, nanographite, tungsten carbide, niobium carbide, boron nitride, zirconia, noble metals, acid-base-stable highly cross-linked polymers, titania, alumina, and thoria.

21. The porous composite particulate material of claim 14, wherein the polymeric material includes an amine polymer.

22. The porous composite particulate material of claim 14, wherein the plurality of composite particles exhibits a particle size in a range from about 0.5 μm to about 10 μm and a surface area of at least about 10 m²/g.

23. The porous composite particulate material of claim 14, wherein the plurality of composite particles exhibits a particle size in a range from about 10 μm to about 250 μm and a surface area of at least about 5 m²/g.

24. A method for using a porous composite particulate material, the method comprising:
placing a porous composite particulate material in a vessel, the porous composite particulate material including,
a plurality of composite particles, each composite particle including:
a generally spherical acid-base-resistant core particle including at least one exterior layer of non-diamond carbon;
a plurality of acid-base-resistant shell particles; and
a cross-linked polymeric layer bonding the plurality of shell particles to the acid-base-resistant core particle;
providing a mobile phase including at least two different components to be separated;
flowing the mobile phase through the porous composite particulate material to physically separate the at least two different components; and
recovering at least one of the two different components that have been separated.

25. The method of claim 24, further comprising cleaning the porous composite particulate material by flowing a cleaning solvent through the particle bed.

26. The method of claim 24, wherein at least one of the cleaning solvent or the mobile phase has a pH greater than about 10 or a pH less than about 2.

27. A separation apparatus, comprising:
a vessel having an inlet and an outlet; and
a porous composite particulate material disposed within the vessel, the porous composite particulate material including,
a plurality of composite particles, a number of the plurality of composite particles including:
an acid-base-resistant core particle including at least one exterior layer of non-diamond carbon;
a plurality of acid-base-resistant shell particles; and
a cross-linked polymeric layer bonding the plurality of shell particles to the acid-base-resistant core particle.

28. The separation apparatus of claim 27, wherein the vessel is configured as a chromatography column.
